(19) United States
(12) Patent Application Publication
(10) Pub. No.: US 2010/0325078 A1
(43) Pub. Date: Dec. 23, 2010

(54) DEVICE AND METHOD FOR RECOGNIZING EMOTION AND INTENTION OF A USER

(76) Inventor: Ho-Sub LEE, Seoul (KR)

Correspondence Address: North Star Intellectual Property Law, PC, P.O. Box 34688, Washington, DC, 20043, US

(21) Appl. No.: 12/710,785

(22) Filed: Feb. 23, 2010

(30) Foreign Application Priority Data
Jun. 22, 2009 (KR) 10-2009-0055467

(51) Int. Cl. G06N 5/02

(52) U.S. Cl. 706/47; 706/54

(57) ABSTRACT

A user intention recognition device and method are provided. The user intention recognition device may be used by a person who is not able to appropriately express their emotion and intention, such as a disabled person, a patient, and the like. The user intention recognition device may determine an emotion of the user based on the communication information of the user, and also, may determine an intention of the user based on the emotion and biometric information of the user. The user intention recognizing device may provide an appropriate output corresponding to the determined intention of the user.

### CROSS-REFERENCE TO RELATED APPLICATION

This application claims the benefit under 35 U.S.C. §119(a) of a Korean Patent Application No. 10-2009-0055467, filed on Jun. 22, 2009, in the Korean Intellectual Property Office, the entire disclosure of which is incorporated herein by reference for all purposes.

### BACKGROUND

1. Field

The following description relates to a technology for recognizing emotion and intention of a user, for example, a user who may have difficulty in expressing their emotion and intentions, such as disabled people, patients, and the like.

2. Description of Related Art

The average lifespan of people has increased significantly in large part due to the development of medical technology. Accordingly, the lifespan of patients who have difficulty expressing their emotions and intentions has been significantly increased.

For example, patients having diseases such as dementia, palsy, and the like, may be a great burden to guardians. For example, patients having a disease causing senility such as dementia, and the like, may have a very low reception, and thus, their memory, cognitive ability, and language ability are diminished. These patients often times have difficulty in expressing their medical intention. For example, the patients may have difficulty expressing their intentions such as ‘wanting to urinate,’ ‘having a headache,’ ‘feeling hunger,’ and the like.

Because the guardians of these patients often spend much more time with the patients, the guardians often know the patient's character, habit, and the like, and may understand the intention of the patient without the patient generating much expression or emotion. However, doctors, and others that work in the medical field who have medical knowledge but do not spend a great deal of time with a patient, may struggle to understand a patient's character, habit, and the like, and may have difficulty in understanding a patient's intention.

FIG. 1 illustrates a conventional example of communication between a patient and a doctor in a related art.

Referring to FIG. 1, generally a patient 110 verbally expresses the patient's condition, symptoms, or emotions, and a medical worker 120 recognizes the intention of the patient 110 based on the expression of the patient 110 and biometric information of the patient 110 and takes an appropriate medical action. The medical worker 120 may be a person with advanced or expert medical knowledge, for example, a doctor, a nurse, a surgeon, a first aid technician, and the like.

If the patient 110 shown in FIG. 1 is not able to appropriately express the patient's condition and/or emotion, such as a person having a disease causing senility, a person suffering from mental retardation, and the like, the medical worker 120 may have difficulty recognizing the intention of the patient 110. A guardian of the patient 110 may know the patient's unique characteristics such as a habit, a character, and the like, and thereby may understand the intention of the patient 110 to some degree. However, because the guardian generally does not have professional medical knowledge, the guardian needs to take the patient 110 to the medical worker 120 or to get advice from the medical worker 120 before taking an action for the patient 110. This may cause difficulty for the guardian to take care of the patient 110.

In addition, the medical worker 120 may not know a unique characteristic of the patient 110, and therefore, may take medical action based only on biometric information of the patient 110. To assist the medical worker 120, the guardian may need to constantly remain at the side of the patient 110 to help the medical worker 120 understand the patient's 110 emotion and condition. This may cause an undue burden for the guardian.

### SUMMARY

In one general aspect, provided is a device for recognizing an intention of a user, the device comprising a data collecting unit to collect communication information of a user via at least one nonverbal communication means, and to collect biometric information of the user, an emotion determining unit to determine an emotion of the user based on the communication information of the user, and an intention determining unit to determine an intention of the user based on the emotion of the user and the biometric information of the user.

The intention determining unit may determine the intention of the user based on rules according to a rule-based expert system which are stored in a rule database.

The rule database may include rules related to medical knowledge.

The emotion determining unit may extract a feature pattern from the communication information of the user, and determine the emotion of the user based on the feature pattern according to pattern recognition.

The emotion determining unit may compare the feature pattern with at least one of data accumulated in advance or statistical information, to determine the emotion of the user.

The at least one of the data accumulated in advance or the statistical information may be stored in the emotion database, and the emotion database may be updated.

The device may be installed in a mobile device and the data collecting unit may collect the communication information of the user and the biometric information of the user from at least one sensing module.

The device may further comprise at least one sensing module to collect the communication information and the biometric information of the user.

The communication information may include at least one of a facial expression, a gaze, a posture, a motion, and a voice, and the biometric information may include at least one of a body temperature, a blood pressure, a pulse rate, and a blood sugar count.

The device may further comprise a communication interface to transmit information related to the intention of the user to an outside source or to receive predetermine information from the outside source.

The device may further comprise an outputting unit to output the intention of the user in the form of at least one of an audio, a video, and a document.

In another aspect, provided is a method for recognizing an intention of a user, the method comprising collecting, using at least one sensing module, communication information of a user via at least one nonverbal communication means and biometric information of the user, determining an emotion of the user based on the communication information of the user, and determining an intention of the user based on the emotion of the user and the biometric information of the user.

The determining of the intention of the user may comprise determining the intention of the user corresponding to the emotion of the user and the biometric information of the user based on rules according to a rule-based expert system that are stored in a rule database.

The determining of the emotion of the user may comprise extracting a feature pattern of the communication information of the user, and determining the emotion of the user based on the feature pattern according to pattern recognition.

In another aspect, provided is a computer-readable storage media including instructions to cause a processor to implement a method comprising collecting, using at least one sensing module, communication information of a user via at least one nonverbal communication means and biometric information of the user, determining an emotion of the user based on the communication information of the user, And determining an intention of the user based on the emotion of the user and the biometric information of the user.

Other features and aspects will be apparent from the following description, the drawings, and the claims.

### BRIEF DESCRIPTION OF THE DRAWINGS

FIG. 1 is a diagram illustrating a conventional example of communication between a patient and a doctor.

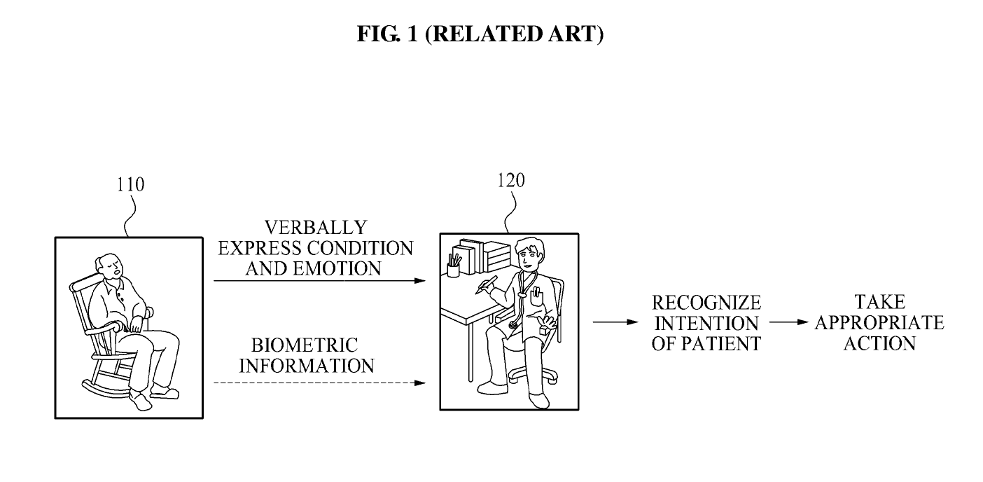

FIG. 2 is a diagram illustrating an example of a user intention recognition device.

FIG. 3 is a diagram illustrating an example of a user intention recognition device worn by a user.

FIG. 4 is a flowchart illustrating an example of a user intention recognition method.

FIG. 5 is a diagram illustrating an example of a mobile device including a user intention recognizing device.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

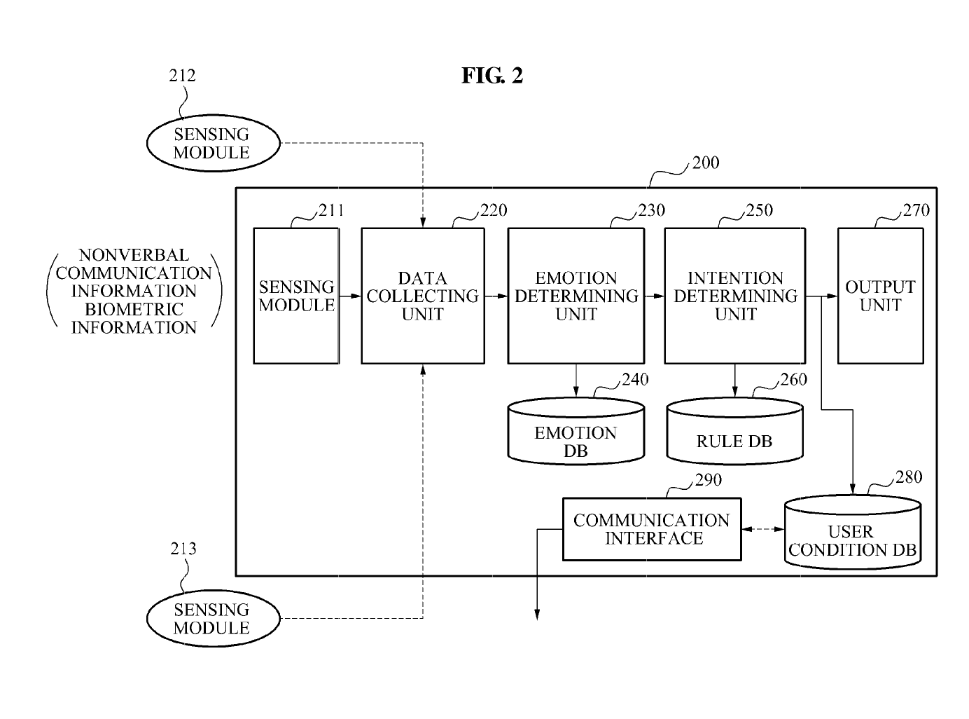

FIG. 2 illustrates an example of a user intention recognition device.

Referring to FIG. 2, the example user intention recognition device 200 includes a sensing module 211, a data collecting unit 220, an emotion determining unit 230, an emotion database 240, an intention determining unit 250, a rule database 260, an output unit 270, a user condition database 280, and a communication interface 290. As shown in FIG. 2, the sensing modules 212 and 213 may be physically separated from the user intention recognition device 200. However, in some embodiments, one or more of the sensing modules may be included in the user intention recognition device 200.

The sensing modules 211, 212, and 213 collect communication information of a user via one or more communication means. The communication information may include nonverbal communication and/or verbal communication. In some embodiments, the sensing modules may collect only nonverbal communication information from the user. The sensing modules 211, 212, 213 may collect biometric information of a user via various biometric equipment or devices. The communication information may include, for example, a facial expression, a gaze, a posture, a motion, a voice, and the like of the user. The biometric information may include, for example, a body temperature, a blood pressure, a pulse rate, a blood sugar count, and the like. As illustrated in FIG. 2, one or more sensing modules may be integrated into the user intention recognition device or may be physically separated from the user intention recognition device.

When a user has trouble expressing emotion via a verbal communication means, the user may use a nonverbal communication means. The user may express emotion through a changing facial expression, a gaze, posture, motion according to the user's emotion, vocally to express an emotion, and the like.

For example, the sensing modules 211, 212, and 213 may include a camera and/or various sensors to trace at least one of the facial expression, the gaze, the posture, and the motion of the user. The sensing modules 211, 212, and 213 may include a microphone and the like to recognize the sound of the user. The sensing modules 211, 212, and 213 may include bio sensors to measure, for example, a body temperature, a blood pressure, a pulse rate, a blood sugar count of the user, and the like.

The data collecting unit 220 collects the communication information and the biometric information measured by the sensing modules 211, 212, and 213. For example, the data collecting unit 220 may accumulatively collect the communication information and the biometric information during a predetermined time

The emotion determining unit 230 determines an emotion of the user based on the communication information collected by the data collecting unit 220. For example, the emotion of the user may be classified into various emotions, for example, joy, anger, sorrow, pleasure, sadness, and the like.

The emotion determining unit 230 may extract a feature pattern of the communication information, and may determine the emotion of the user based on the feature pattern according to a pattern recognition. The pattern recognition may include, for example, a field of a Machine Learning, and may include a technology that categorizes a physical object or an event into at least one of various categories.

The emotion determining unit 230 may perform pattern recognition using the emotion database 240 that stores data and/or statistical information. For example, emotions, such as joy, anger, sorrow, pleasure, sadness and the like, each may have a unique pattern, and the emotion determining unit 230 may determine an emotion corresponding to the feature pattern extracted from the communication information of the user, from among the emotions to determine the emotion of the user.

For example, if a value corresponding to a feature pattern extracted from the facial expression of the user is greater than 4.5, and a value corresponding to a feature pattern extracted from a voice is greater than 3.0, the emotion of the user may be determined to be joy. The values and feature patterns are merely for example purposes only. Any desired feature patterns may be extracted and evaluated to determine an emotion of a user. The feature patterns may be given values, or the feature patterns may be evaluated in another manner.

While the emotion database 240 is included in the intention recognition device 200, it is possible for the emotion database 240 to be formed separate from the user intention recognition device 200. If the emotion database is formed separately, the user intention recognition device 200 may download information from the emotion database 240 using various communication means known in the art, for example a network such as a wireless network, and the like.

The intention determining unit 250 may determine an intention of the user based on the emotion of the user determined by the emotion determining unit 230 and the biometric information of the user collected by the data collecting unit 220. The user's intention may include a number of different intentions. In the example of a patient, the intention may be various intentions, such as ‘wanting to urinate,’ ‘having an headache,’ ‘feeling hunger,’ ‘feeling cold,’ and the like.

The intention determining unit 250 may determine the intention of the user with a high degree of accuracy, using the rule database 260 according to a Rule-based Expert System. That is, the intention determining unit 250 may determine the intention of the user based on the emotion of the user and the biometric information using the rule database 260.

The Rule-based Expert System may include a consultative computer system to which knowledge of experts are artificially provided, thereby enabling a layman to use expert knowledge in a corresponding technology filed. For example, the Rule-based Expert System may perform inference based on a plurality of rules defined in advance.

The rule database 260 may store the plurality of rules based on medical knowledge of medical experts. The plurality of rules may be defined to be diverse. For example, the plurality of rules may be defined to be different based on various emotions of the user and biometric information of the user.

For example, when a body temperature is greater than or equal to 38° C., a blood pressure is greater than or equal to 140 mmHg, and the emotion of the user is sorrow, the intention of the user may be determined to be ‘wanting to urinate.’ If the emotion of a patient with dementia dramatically changes during a short time period, a blood pressure is greater than or equal to 130 mmHg, and a pulse rate increases, it may be determined that the patient has a symptom of delirium. A rule for responding to the delirium of the dementia patient may include information about calling a medical team, not leaving the patient alone, treating the patient gently, and the like.

The emotion database 240 and the rule database 260 may be updated by the guardian and/or the medical worker. For example, the guardian may update related data based on a unique characteristic of the patient, and the like.

The output unit 270 outputs the determined intention of the user. For example, the output unit 270 may output the intention of the user in various forms, such as an audio, a video, a document, and the like. The intention of the user corresponding to the determined intention and the collected biometric information may be stored in the user condition database 280.

The communication interface 290 may transmit data stored in the user condition database 280 and/or may receive predetermined data from an outside source. For example, the communication interface 290 may transmit the intention of the user to a guardian or a medical worker.

In the example user intention recognition device illustrated in FIG. 2, the rule database 260 and the user condition database 280 are included in the device. However, the rule database 260 and/or the user condition database 280 may be installed outside of the user intention recognizing device 200. The user intention recognizing device 200 may access the rule database 260 and the user condition database 280 using various communication means.

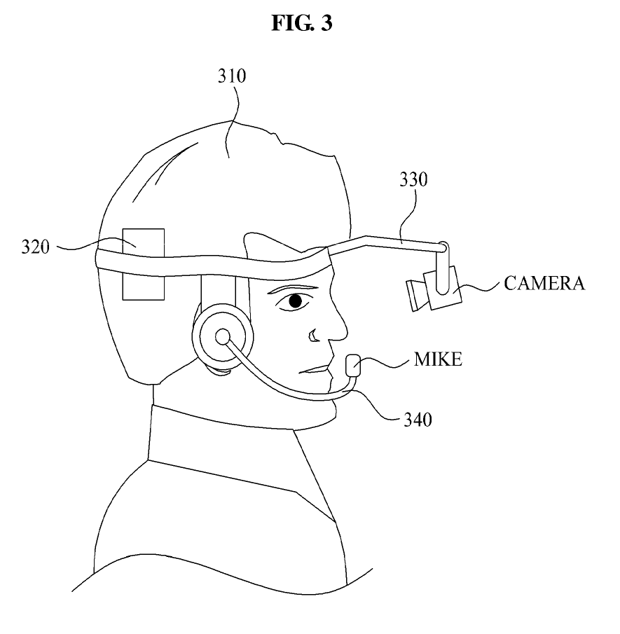

FIG. 3 illustrates an example of a user intention recognition device worn by a user.

Referring to FIG. 3, the user intention recognizing device 320 is connected to a band that surrounds a forehead and is attached to a user 310. The user intention recognizing device 320 may be manufactured as a form of a mobile device or a mobile terminal.

A facial expression of the user 310, a gaze of the user 310, and the like may be imaged through a camera 330, and a voice of the user 310 may be recognized by a microphone 340. Biometric information of the user 310 may be measured through a sensing module included inside the user intention recognizing device 320.

In some embodiments, the user intention recognizing device 320 may be manufactured in a form of a stationary device, as opposed to in the form of a mobile terminal. For example, the user intention recognizing device 320 may be manufactured as a device that is attached to a bed, a chair, and the like.

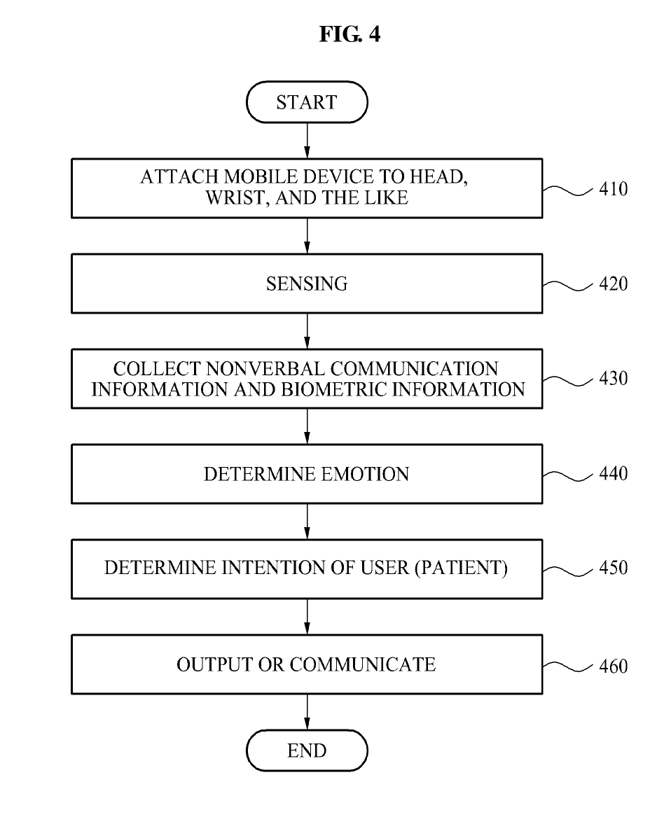

FIG. 4 is a flowchart that illustrates an example of a user intention recognition method.

Referring to FIG. 4, in 410 the user may attach a mobile device including the user intention recognition device, for example, to a head, a wrist, and the like. The sensing modules for the user intention recognition device may be connected to the mobile device or may be separated from the mobile device.

The sensing modules measure communication information of the user and biometric information of the user in 420.

The user intention recognition device collects communication information and the biometric information measured by the sensing modules in 430.

In 440, the user intention recognizing device may determine emotion of the user based on the communication information according to pattern recognition. For example, the user intention recognizing device may extract a feature pattern from the communication information of the user, and may determine the emotion of the user based on the feature pattern according to pattern recognition.

In 450, the user intention recognition device may determine the intention of a user based on the emotion of the user and the biometric information. For example, the user intention recognition device may determine the intention of the user corresponding to the emotion and the biometric information of the user using the rules stored in a rule database according to a Rule-based Expert System. For example, the rule database according to the Rule-based Expert System may store rules related to medical knowledge.

In 460, the user intention recognition device may output the determined intention of the user in various forms or may transmit information related to the intention of the user to a guardian or a medical worker.

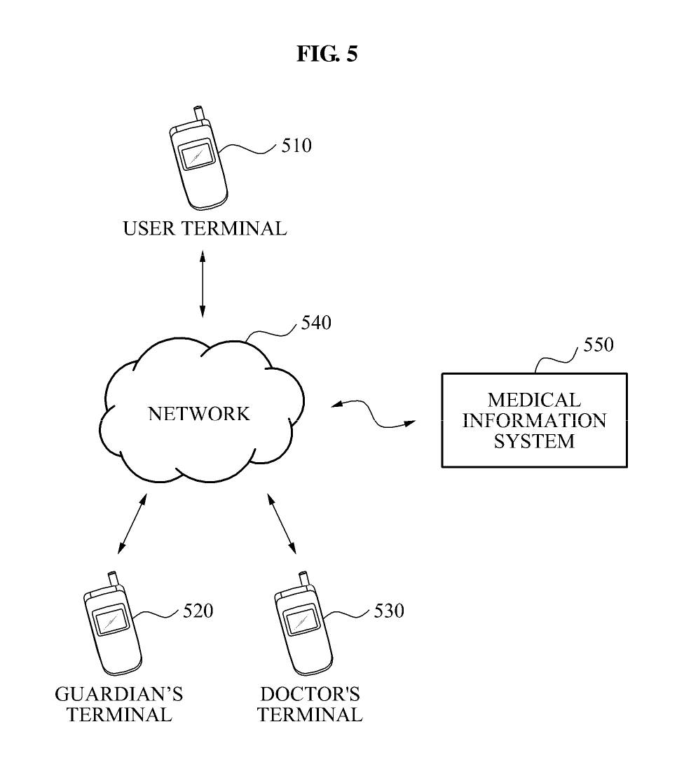

FIG. 5 illustrates an example of using a mobile device including a user intention recognizing device.

Referring to FIG. 5, a user (patient) terminal 510, a guardian's terminal 520, and a medical worker's terminal 530, are connected to each other through a network 540.

The user intention recognition device may be installed in the user terminal 510, and information about the intention of the user recognized by the user intention recognition device may be displayed in the user terminal 510 or may be transmitted to the guardian's terminal 520 or to the medical worker's terminal 530 through the network 540.

The user terminal 510 may transmit an emotion, an intention, biometric information, and/or communication information of the user to a medical information system 550. The medical information system 550 may store the emotion, the intention, the biometric information, and/or the communication information of the user. For example, the medical information system 550 may transmit the emotion, the intention, the biometric information, and/or the communication information to the guardian's terminal 520 or the medical worker's terminal 530, through the network 540.

A user intention recognizing device and method may synthetically consider the communication information and biometric information and may accurately recognize intention of patients who are not able to appropriately express their intention. Accordingly, guardians may have a relatively smaller burden in caring for the patients.

Also, the user intention recognition device and method may provide a medically reliable technology using a rule database according to a Rule-based Expert System.

The user intention recognition device and method may accurately determine emotion of patients using pattern recognition.

Also, the user intention recognition device and method may provide an emotion database or a rule database which are able to be updated by guardians or medical workers based on a unique characteristic of patients.

As a non-exhaustive illustration only, a terminal described herein may refer to mobile devices such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, and devices such as a desktop PC, a high definition television (HDTV), an optical disc player, a setup box, and the like capable of wireless communication or communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described examples, or vice versa. In addition, a computer-readable storage medium may be distributed among computer systems connected through a network and computer-readable codes or program instructions may be stored and executed in a decentralized manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A device for recognizing an intention of a user, the device comprising:
a data collecting unit to collect communication information of a user via at least one nonverbal communication means, and to collect biometric information of the user;
an emotion determining unit to determine an emotion of the user based on the communication information of the user; and
an intention determining unit to determine an intention of the user based on the emotion of the user and the biometric information of the user.

2. The device of claim 1, wherein the intention determining unit determines the intention of the user based on rules according to a rule-based expert system which are stored in a rule database.

3. The device of claim 2, wherein the rule database includes rules related to medical knowledge.

4. The device of claim 1, wherein the emotion determining unit extracts a feature pattern from the communication information of the user, and determines the emotion of the user based on the feature pattern according to pattern recognition.

5. The device of claim 4, wherein the emotion determining unit compares the feature pattern with at least one of data accumulated in advance or statistical information, to determine the emotion of the user.

6. The device of claim 5, wherein the at least one of the data accumulated in advance or the statistical information are stored in the emotion database, and the emotion database is updated.

7. The device of claim 1, wherein:
the device is installed in a mobile device; and
the data collecting unit collects the communication information of the user and the biometric information of the user from at least one sensing module.

8. The device of claim 1, further comprising:
at least one sensing module to collect the communication information and the biometric information of the user.

9. The device of claim 1, wherein the communication information includes at least one of a facial expression, a gaze, a posture, a motion, and a voice, and the biometric information include at least one of a body temperature, a blood pressure, a pulse rate, and a blood sugar count.

10. The device of claim 1, further comprising:
a communication interface to transmit information related to the intention of the user to an outside source or to receive predetermine information from the outside source.

11. The device of claim 1, further comprising:
an outputting unit to output the intention of the user in the form of at least one of an audio, a video, and a document.

12. A method for recognizing an intention of a user, the method comprising:
collecting, using at least one sensing module, communication information of a user via at least one nonverbal communication means and biometric information of the user;
determining an emotion of the user based on the communication information of the user; and
determining an intention of the user based on the emotion of the user and the biometric information of the user.

13. The method of claim 12, wherein the determining of the intention of the user comprises determining the intention of the user corresponding to the emotion of the user and the biometric information of the user based on rules according to a rule-based expert system that are stored in a rule database.

14. The method of claim 12, wherein the determining of the emotion of the user comprises:
extracting a feature pattern of the communication information of the user; and
determining the emotion of the user based on the feature pattern according to pattern recognition.

15. A computer-readable storage media including instructions to cause a processor to implement a method comprising:
collecting, using at least one sensing module, communication information of a user via at least one nonverbal communication means and biometric information of the user;
determining an emotion of the user based on the communication information of the user; and
determining an intention of the user based on the emotion of the user and the biometric information of the user.
